(19) United States
(12) Patent Application Publication
(10) Pub. No.: US 2024/0405440 A1
(43) Pub. Date: Dec. 5, 2024

(54) REFLECTOR ANTENNA DEVICE

(71) Applicant: Mitsubishi Electric Corporation, Tokyo (JP)

(72) Inventors: Hiromasa NAKAJIMA, Tokyo (JP); Shinichi YAMAMOTO, Tokyo (JP); Yasuhiro NISHIOKA, Tokyo (JP)

(73) Assignee: Mitsubishi Electric Corporation, Tokyo (JP)

(21) Appl. No.: 18/801,927

(22) Filed: Aug. 13, 2024

Related U.S. Application Data
(63) Continuation of application No. PCT/JP2022/010463, filed on Mar. 10, 2022.

(51) Int. Cl. H01Q 15/14; H01Q 15/23

(52) U.S. Cl. CPC H01Q 15/14; H01Q 15/23

(57) ABSTRACT

A reflector antenna device includes: a primary radiator to radiate a radio wave; a primary reflector including a dielectric plate of a flat plate shape, and resonance elements that are aligned on a reflection surface of the dielectric plate, and each adjust a phase of a reflected wave of the incident radio wave; and a secondary reflector including a reflection surface on which the radio wave radiated from the primary radiator is incident and that reflects the incident radio wave toward the primary reflector, the reflection surface making a route length from the primary radiator to the reflection surface of the primary reflector of a radio wave of a high frequency radiated from the primary radiator longer than a route length from the primary radiator to the reflection surface of the primary reflector of a radio wave of a low frequency radiated from the primary radiator.

### CROSS REFERENCE TO RELATED APPLICATION

This application is a Continuation of PCT International Application No. PCT/JP2022/010463, filed on Mar. 10, 2022, which is hereby expressly incorporated by reference into the present application.

### TECHNICAL FIELD

The present disclosure relates to a reflector antenna device that includes a primary radiator and a reflector of a flat plate shape.

### BACKGROUND ART

In recent years, as for antennas for wireless communication and radars, reflect arrays that adopt reflecting plates of flat shapes with simple structures have been developed.

For example, Patent Literature 1 describes a reflect array antenna that optimizes an arrangement interval of resonance elements aligned on the surface of a reflecting plate of a flat plate shape, and prevents occurrence of a grating lobe.

Furthermore, Patent Literature 2 describes a reflect array antenna that can broaden a band by determining positions of a reflecting plate and a primary radiator.

### CITATION LIST

### Patent Literatures

Patent Literature 1: JP 2016-92633 A
Patent Literature 2: JP 2017-79460 A

### SUMMARY OF INVENTION

### Technical Problem

However, although Patent Literatures 1 and 2 propose broadening bands, residual aberration that occurs at other than a set frequency decreases a gain, and these reflect array antennas still have narrow band characteristics compared to a parabolic antenna that includes a primary radiator that is a horn antenna and a reflecting plate of a paraboloid shape opposing to each other, and are requested to further broaden a band.

The present disclosure has been made in light of the above point, and an object of the present disclosure is to provide a reflector antenna device that has high aperture efficiency in a wide frequency band.

### Solution to Problem

A reflector antenna device according to the present disclosure includes: a primary radiator to radiate a radio wave of a set frequency band; a primary reflector including a dielectric plate of a flat plate shape, and a plurality of resonance elements that are aligned on a surface of the dielectric plate that is a reflection surface for reflecting the radio wave, and each adjust a phase of a reflected wave of the incident radio wave; and a secondary reflector including a reflection surface on which the radio wave radiated from the primary radiator is incident and that reflects the incident radio wave toward the primary reflector, the reflection surface making a route length from the primary radiator to the reflection surface of the primary reflector of a radio wave of a high frequency in the frequency band radiated from the primary radiator longer than a route length from the primary radiator to the reflection surface of the primary reflector of a radio wave of a low frequency in the frequency band radiated from the primary radiator.

### Advantageous Effects of Invention

According to the present disclosure, the route length from the primary radiator to the reflection surface of the primary reflector is adjusted, so that it is possible to provide high aperture efficiency in a wide frequency band at frequencies other than a set frequency.

### BRIEF DESCRIPTION OF DRAWINGS

FIG. 1 is a configuration diagram illustrating a reflector antenna device according to Embodiment 1 seen from a side.

FIG. 2 is a side view illustrating a primary reflector in the reflector antenna device according to Embodiment 1.

FIG. 3 is a front view illustrating the primary reflector in the reflector antenna device according to Embodiment 1.

FIG. 4 is a plan view illustrating an example of a resonance element in the reflector antenna device according to Embodiment 1.

FIG. 5 is a plan view illustrating another example of the resonance element in the reflector antenna device according to Embodiment 1.

FIG. 6 is a plan view illustrating another example of the resonance element in the reflector antenna device according to Embodiment 1.

FIG. 7 is a plan view illustrating another example of the resonance element in the reflector antenna device according to Embodiment 1.

FIG. 8 is a plan view illustrating another example of the resonance element in the reflector antenna device according to Embodiment 1.

FIG. 9 is a plan view illustrating another example of the resonance element in the reflector antenna device according to Embodiment 1.

FIG. 10 is a side view illustrating another example of the primary reflector in the reflector antenna device according to Embodiment 1.

FIG. 11 is a perspective view illustrating a secondary reflector in to the reflector antenna device according Embodiment 1.

FIG. 12 is a cross-sectional view illustrating a reflection hole of the secondary reflector in the reflector antenna device according to Embodiment 1.

FIG. 13 is a view for describing the positions of virtual images of the primary radiator with respect to the primary reflector produced by the secondary reflector in the reflector antenna device according to Embodiment 1.

FIG. 14 is a view for describing wavefronts of spherical waves of radio waves radiated by the primary radiator from the positions of the virtual images of the primary radiator produced by the secondary reflector in the reflector antenna device according to Embodiment 1, and route length differences.

### DESCRIPTION OF EMBODIMENTS

### Embodiment 1

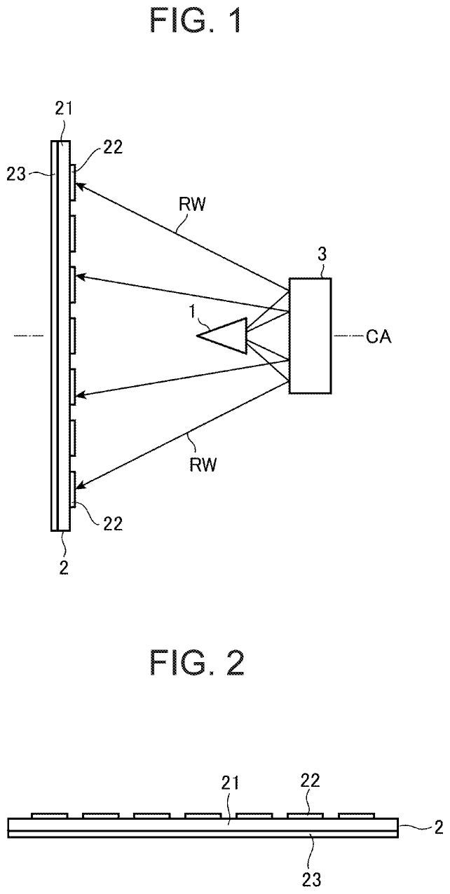

A reflector antenna device according to Embodiment 1 will be described with reference to FIGS. 1 to 14.

The reflector antenna device includes a primary radiator 1, a primary reflector 2, and a secondary reflector 3.

The reflector antenna device is a reflector antenna device in which center axes CA of the primary radiator 1, the primary reflector 2, and the secondary reflector 3 match as illustrated in FIG. 1, and adopts a center feed system for a mirror surface system in which the primary radiator 1 is aligned between the primary reflector 2 and the secondary reflector 3.

Note that the reflector antenna device is not limited to the center feed system, and may be a reflector antenna device of an offset mirror system in which the primary radiator 1 has such a positional relationship as to form an offset with respect to the primary reflector 2, or the primary radiator 1 and the secondary reflector 3 have such a positional relationship as to form an offset with respect to the primary reflector 2.

Furthermore, the reflector antenna device may further include a reflecting plate in addition to the primary reflector 2 and the secondary reflector 3.

The reflector antenna device of the center feed system will be described below.

The primary radiator 1 radiates a plurality of radio waves RW of different frequencies in a wide band from a low frequency f_{L} to a high frequency f_{H} toward the secondary reflector 3.

The low frequency f_{L} indicates a frequency at a lower end of a set frequency band of a radio wave radiated from the primary radiator 1, and the high frequency f_{H} indicates a frequency at an upper end of the set frequency band of the radio wave radiated from the primary radiator 1.

The primary radiator 1 radiates radio waves of horizontal and vertical polarizations. The primary radiator 1 is a horn antenna.

As illustrated in FIGS. 1 to 3, the primary reflector 2 includes a dielectric plate 21, a plurality of resonance elements 22 aligned on the surface of the dielectric plate 21 that is a reflection surface that reflects the radio waves, and a metal plate 23 provided on the back surface of the dielectric plate 21.

The primary reflector 2 is a so-called reflect array that uses a reflecting plate of a flat plate shape.

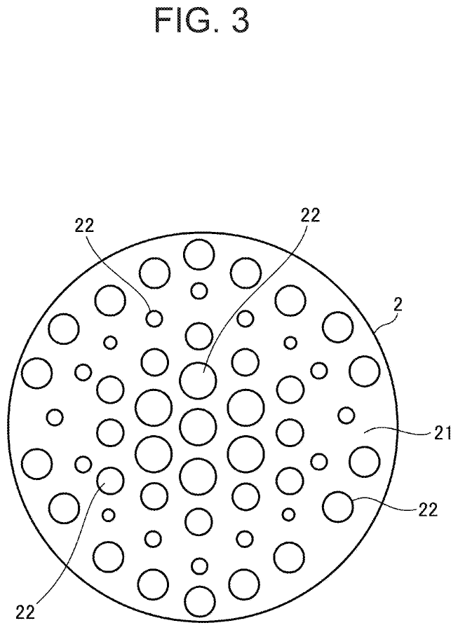

The dielectric plate 21 has a circular flat plate shape as illustrated in FIG. 3.

Each resonance element 22 adjusts the phase (hereinafter, referred to as a reflection phase) of a reflected wave of an incident radio wave.

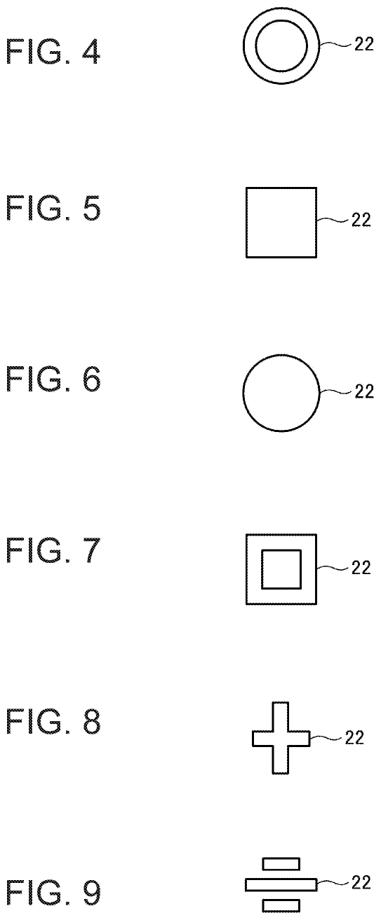

Each resonance element 22 has a circular ring shape as illustrated in FIG. 4, and has the ring shape that has the size matching a position on the surface of the dielectric plate 21, that is, the diameter matching the position on the surface of the dielectric plate 21.

Note that each resonance element 22 may have any shape such as a rectangular patch type as illustrated in FIG. 5, a circular patch type as illustrated in FIG. 6, a rectangular ring type as illustrated in FIG. 7, a cross type as illustrated in FIG. 8, and a rectangular patch type formed by a plurality of the rectangular patches as illustrated in FIG. 9, or may also have a shape formed by combining a plurality of shapes.

Furthermore, the plurality of resonance elements 22 are not limited to the resonance elements arranged on one layer of the same plane on the surface of the dielectric plate 21, and, as illustrated in FIG. 10, the plurality of resonance elements 22 may be separately arranged on two layers or may be arranged on three or more layers.

The reflection phase of the primary reflector 2 is determined on the basis of the shape and the size of each resonance element 22, intervals between the plurality of resonance elements 22, and the relative permittivity and the thickness of the dielectric plate 21.

The reflection phase of the primary reflector 2 depends on a route length that depends on the position on the surface of the dielectric plate 21 and that is from the primary radiator 1 to the reflection surface that is the surface of the dielectric plate 21, in other words, depends on a route length difference that is a length between a wavefront of a spherical wave incident on the primary reflector 2 and the surface of the dielectric plate 21.

Consequently, the primary reflector 2 can control a value of the reflection phase by arranging the resonance elements 22 having the different shapes and sizes on the surface of the dielectric plate 21 depending on the position on the surface of the dielectric plate 21. The primary the reflector 2 determines the shapes and the sizes of resonance elements 22 and converts the spherical wave into a plane wave on an opening surface of the primary reflector 2 to reflect, in such a way as to make the spherical wave incident on the surface of the primary reflector 2 become the plane wave on the opening surface of the primary reflector 2.

In Embodiment 1, in such a way as to make the spherical wave incident on the primary reflector 2 after a radio wave RW_{M} of an intermediate frequency f_{M} radiated from the primary radiator 1 is reflected by the secondary reflector 3 become the plane wave on the opening surface of the primary reflector 2, the shape and the size of each of the plurality of resonance elements 22 of the primary reflector 2 are determined depending on the position on the surface of the dielectric plate 21, and the plurality of resonance elements 22 are arranged on the surface of the dielectric plate 21.

The intermediate frequency f_{M} is an intermediate value of the high frequency f_{H} and the low frequency f_{L} radiated from the primary radiator 1.

The secondary reflector 3 constitutes a radio wave route length adjuster that adjusts the route length from the primary radiator 1 to the reflection surface of the primary reflector 2 depending on the frequency of the radio wave radiated from the primary radiator 1.

The secondary reflector 3 includes a reflection surface that reflects the radio wave radiated from the primary radiator 1.

The reflection surface of the secondary reflector 3 makes a route length from the primary radiator 1 to the reflection surface of the primary reflector 2 of a radio wave RW_{H} of the high frequency f_{H} radiated from the primary radiator 1 longer than a route length from the primary radiator 1 to the reflection surface of the primary reflector 2 of a radio wave RW_{L} of the low frequency f_{L} radiated from the primary radiator 1.

The reflection surface of the secondary reflector 3 has a function of adjusting the route length differences that are lengths between the wavefronts of the spherical waves of the radio waves RW_{L}, RW_{M}, and RW_{H} incident on the primary reflector 2, and the surface of the dielectric plate 21 to satisfy the following equation (1), in a case where the radio waves RW_{L}, RW_{M}, and RW_{H} of the low frequency f_{L}, the intermediate frequency f_{M}, and the high frequency f_{H} are radiated from the primary radiator 1 and the radiated radio waves RW_{L}, RW_{M}, and RW_{H} are incident on the reflection surface.

$${λ}_{L} / {d}_{L} = {λ}_{M} / {d}_{M} = {λ}_{H} / {d}_{H} \qquad ( 1 )$$

In the equation (1), Δ_{L}, Δ_{M}, and Δ_{H} represent wavelengths of the radio waves RW_{L}, RW_{M}, and RW_{H} of the low frequency f_{L}, the intermediate frequency f_{M}, and the high frequency f_{H}, and d_{L}, d_{M}, and de represent route length differences between the wavefronts of the spherical waves of the radio waves RW_{L}, RW_{M}, and RW_{H} of the low frequency f_{L}, the intermediate frequency f_{M}, and the high frequency f_{H}, and the surface of the dielectric plate 21.

That is, to equalize a rate Δ_{L}/d_{L} of the wavelength λ_{L} of the radio wave RW_{L} of the low frequency f_{L} and the route length difference di of the radio wave RW of the low frequency f_{L}, a rate λ_{ML}/d_{M} of the wavelength λ_{M} of the radio wave RW_{M} of the intermediate frequency f_{M} and the route length difference d_{M} of the radio wave RW_{M} of the intermediate frequency f_{M}, and a rate λ_{H}/d_{H} of the wavelength λ_{H} of the radio wave RW_{H} of the high frequency f_{H} and the route length difference du of the radio wave RW_{H} of the high frequency f_{H}, the secondary reflector 3 adjusts the route lengths from the primary radiator 1 to the surface of the dielectric plate 21 of the radio waves RW_{L}, RW_{M}, and RW_{H} of the low frequency f_{L}, the intermediate frequency f_{M}, and the high frequency f_{H}.

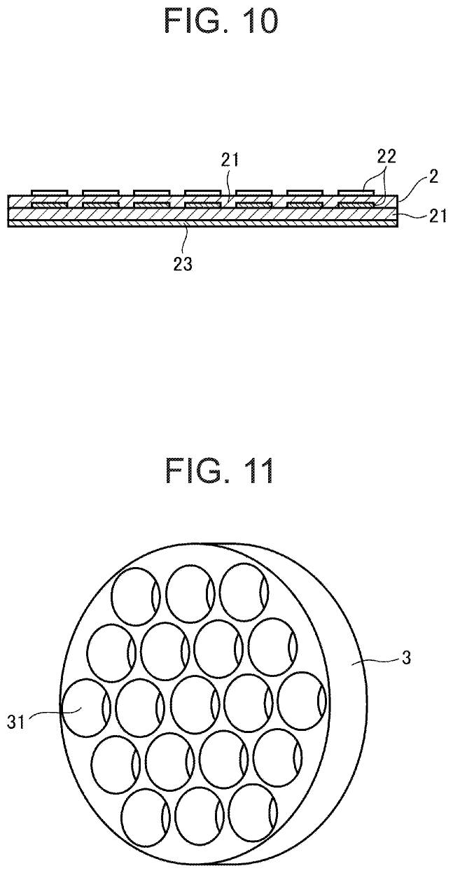

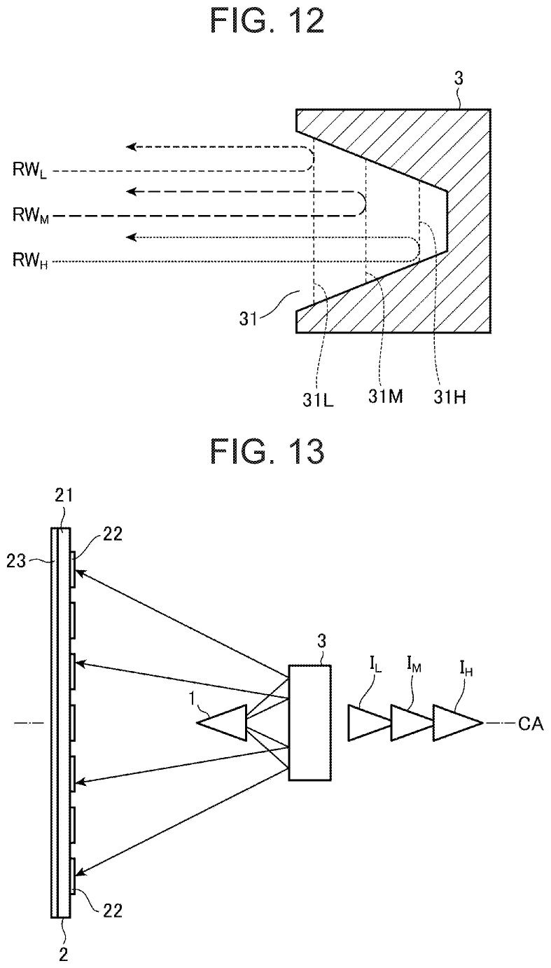

The secondary reflector 3 includes a plurality of reflection holes 31 in the reflection surface as illustrated in FIGS. 11 and 12.

As illustrated in FIG. 12, each of the plurality of reflection holes 31 has a truncated conical shape on which the radio wave is incident, that has one end that is an opening and an other end that is a bottom, and whose diameter size continuously changes from an opening surface of the opening of the one end to the surface of the bottom.

Note that the shape of the reflection hole 31 is not limited to the truncated cone, is only required to have a shape whose hole diameter narrows from the opening surface of the opening of the one end to the surface of the bottom, and may have a shape whose area of the opening surface is wider than the area of the bottom surface, a shape that becomes smaller from the opening to the bottom surface stepwise, and a shape that becomes smaller in a curved shape from the opening to the bottom surface.

Furthermore, the shape of the cross section of the shape of the reflection hole 31 parallel to the opening surface is not limited to a circular shape, and may be an elliptical shape or a quadrangular shape that is a rectangular shape or a square shape. The hole diameter in a case of the quadrangular shape is the length of one of sides of the quadrangular shape in Embodiment 1.

Hereinafter, although the shape of the reflection hole 31 will be described as the truncated cone, the same applies to the other shapes and description thereof will be omitted.

As illustrated in FIG. 12, as for the reflection hole 31 formed in the reflection surface of the secondary reflector 3, the hole diameter at a position 31, close to the opening, that is, the opening surface is set to the diameter that cuts off the radio wave RW_{L} of the low frequency f_{L}, the hole diameter at a position 31_{H} close to the bottom, that is, the bottom surface is set to the diameter that cuts off the radio wave RW_{H} of the high frequency f_{H}, and the hole diameter at a position 31_{M} between the position 31_{L} and the position 31_{H} is set to the diameter that cuts off the radio wave RW_{M} of the intermediate frequency f_{M}.

When the radio wave RW_{L} of the low frequency f_{L} is incident on the reflection surface of the secondary reflector 3, the radio wave RW_{L} of the low frequency f_{L} is cut off at the position 31_{L}, and then the radio wave RW_{L} of the low frequency f_{L} is reflected at the position 31_{L}.

When the radio wave RW_{M} of the intermediate frequency f_{M} is incident on the reflection surface of the secondary reflector 3, the radio wave RW of the intermediate frequency f_{M} is cut off at the position 31_{M}, and then the radio wave RW_{M} of the intermediate frequency f_{M} is reflected at the position 31_{M}.

When the radio wave RW_{H} of the high frequency f_{H} is incident on the reflection surface of the secondary reflector 3, the radio wave RW_{H} of the high frequency f_{H} is cut off at the position 31_{H}, and then the radio wave RW_{H} of the high frequency f_{H} is reflected at the position 31_{H}.

The secondary reflector 3 changes a reflection position of the radio wave in the reflection hole 31 depending on the frequency of the radio wave radiated from the primary radiator 1, and adjusts the route length from the primary radiator 1 to the surface of the dielectric plate 21 of the primary reflector 2 depending on the frequency of the radio wave radiated from the primary radiator 1.

That is, the secondary reflector 3 makes the route length of the radio wave RW_{M} of the intermediate frequency f_{M} longer than the route length of the radio wave RW_{L} of the low frequency f_{L}, and makes the route length of the radio wave RW_{H} of the high frequency f_{H} much longer.

Note that the intermediate frequency f_{M} has been typically described as the intermediate frequency between the low frequency f_{L} and the high frequency f_{H}, is not limited to one intermediate frequency, and may include a plurality of intermediate frequencies.

Furthermore, since the secondary reflector 3 adjusts the route length from the primary radiator 1 to the surface of the dielectric plate 21 of the primary reflector 2 depending on the frequency of the radio wave radiated from the primary radiator 1, a position of a virtual image of the primary radiator 1 with respect to the primary reflector 2 produced by the secondary reflector 3 also changes depending on the frequency.

That is, as illustrated in FIG. 13, a position 1; of the virtual image of the primary radiator 1 that radiates the radio wave RW_{L} of the low frequency f_{L} is the closest to the primary reflector 2, and a position 1_{M} of the virtual image of the primary radiator 1 that radiates the radio wave RW_{M} of the intermediate frequency f_{M} and a position 1_{H} of the virtual image of the primary radiator 1 that radiates the radio wave RW_{H} of the high frequency f_{H} are become more distant from the primary reflector 2 in order.

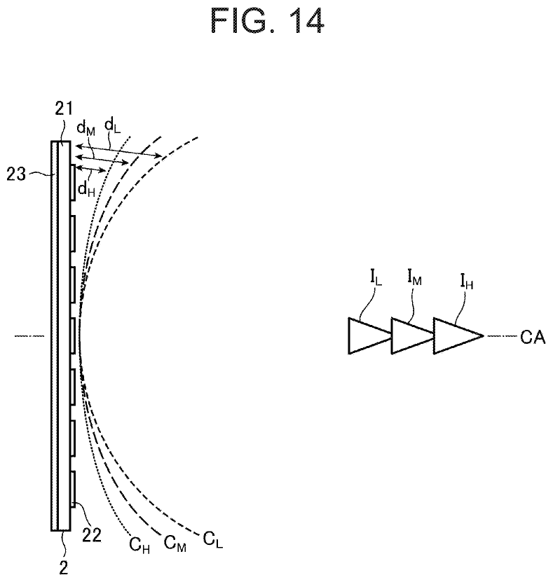

A curvature C_{L} of the wavefront of the spherical wave of the radio wave RW_{L} radiated by the primary radiator 1 from the position 1_{L} of the virtual image that is closest to the primary reflector 2 is large as illustrated in FIG. 14, and the route length difference d_{L} is long.

A curvature C_{H} of the wavefront of the spherical wave of the radio wave RW_{H} radiated by the primary radiator 1 from the position 1_{H} of the virtual image that is the most distant from the primary reflector 2 is small, and the route length difference d_{H} is short.

A curvature CM of the wavefront of the spherical wave of the radio wave RW_{M} radiated by the primary radiator 1 from the position 1_{H} of the virtual image between the position 11 of the virtual image and the position 1_{H} of the virtual image is an intermediate curvature between the curvature C_{L} and the curvature C_{H}, and the route length difference d_{M} is an intermediate route length difference between the route length difference di and the route length difference dx.

Consequently, by adjusting the route length differences d_{M}, d_{L}, and d_{H} to satisfy the above equation (1), it is possible to reduce a phase error caused when the frequency of the radio wave RW radiated from the primary radiator 1 changes, and widen the band of the reflector antenna device.

That is, in such a way as to reflect the spherical wave incident on the primary reflector 2 after the radio wave RW_{M} of the intermediate frequency f_{M} radiated from the primary radiator 1 is reflected by the secondary reflector 3 to form the plane wave on the opening surface of the primary reflector 2, the shape and the size of each of the plurality of resonance elements 22 of the primary reflector 2 are determined depending on the position on the surface of the dielectric plate 21, and the resonance elements 22 are arranged on the surface of the dielectric plate 21.

Hence, according to the reflector antenna device according to Embodiment 1, the secondary reflector 3 adjusts the route lengths of the radio waves that reach the primary reflector 2 to satisfy the above equation (1), so that the spherical wave incident on the primary reflector 2 after each of the radio wave RW_{L} of the low frequency f_{L} and the radio wave RW_{H} of the high frequency f_{H} radiated from the primary radiator 1 is reflected by the secondary reflector 3 is also reflected in such a way as to be converted into the plane wave on the opening surface of the primary reflector 2.

Next, an operation of the reflector antenna device according to Embodiment 1 will be described.

First, a case where the radio wave RW_{M} of the intermediate frequency f_{M} is radiated from the primary radiator 1 will be described.

The radio wave RW_{M} of the intermediate frequency f_{M} from the primary radiator 1 is incident on the reflection surface of the secondary reflector 3. The radio wave RW_{M} of the intermediate frequency f_{M} incident on the reflection surface of the secondary reflector 3 is cut off at the position 31_{M} of the reflection hole 31 formed in the reflection surface of the secondary reflector 3, and therefore is reflected at the position 31_{M} of the reflection hole 31.

The radio wave RW_{M} of the intermediate frequency f_{M} reflected at the position 31_{M} of the reflection hole 31 is incident on the primary reflector 2, the reflection phase of the radio wave RW_{M} of the intermediate frequency f_{M} incident on the primary reflector 2 is adjusted by the plurality of resonance elements 22 of the primary reflector 2, and the primary reflector 2 converts the spherical wave of the radio wave RW_{M} of the intermediate frequency f_{M} into the plane wave on the opening surface of the primary reflector 2 to reflect.

Furthermore, when the radio wave RW_{L} of the low frequency f_{L} is radiated from the primary radiator 1, the radio wave RW_{L} of the low frequency f_{L} from the primary radiator 1 is incident on the reflection surface of secondary reflector 3. The radio wave RW_{L} of the low frequency f_{L} incident on the reflection surface of the secondary reflector 3 is cut off at the position 311 of the reflection hole 31 formed in the reflection surface of the secondary reflector 3, and therefore is reflected at the position 311 of the reflection hole 31.

The radio wave RW_{L} of the low frequency f_{L} reflected at the position 311 of the reflection hole 31 is incident on the primary reflector 2. The rate λ_{L}/d_{L} of the wavelength λ_{L} of the radio wave RW_{L} of the low frequency f_{L} and the route length difference di satisfies the above equation (1), so that the reflection phase of the radio wave RW_{L} of the low frequency f_{L} incident on the primary reflector 2 is adjusted by the plurality of resonance elements 22 of the primary reflector 2, and the spherical wave of the radio wave RW_{L} of the low frequency f_{L} is converted into the plane wave on the opening surface of the primary reflector 2 and reflected.

Furthermore, when the radio wave RW_{H} of the high frequency f is radiated from the primary radiator 1, the radio wave RW_{H} of the high frequency f_{H} from the primary radiator 1 is incident on the reflection surface of secondary reflector 3. The radio wave RW_{H} of the high frequency f_{H} incident on the reflection surface of the secondary reflector 3 is cut off at the position 31: of the reflection hole 31 formed in the reflection surface of the secondary reflector 3, and therefore is reflected at the position 31: of the reflection hole 31.

The radio wave RW_{H} of the high frequency f_{H} reflected at the position 31_{H} of the reflection hole 31 is incident on the primary reflector 2. The rate Δ_{H}/d_{H} of the wavelength λ_{H} of the radio wave RW_{H} of the high frequency f_{H} and the route length difference dx satisfies the above equation (1), so that the reflection phase of the radio wave RW_{H} of the high frequency f_{H} incident on the primary reflector 2 is adjusted by the plurality of resonance elements 22 of the primary reflector 2, and the spherical wave of the radio wave RW_{H} of the high frequency f_{H} is converted into the plane wave on the opening surface of the primary reflector 2 and reflected.

As described above, the secondary reflector 3 that makes the route length from the primary radiator 1 to the reflection surface of the primary reflector 2 of the radio wave RW_{H} of the high frequency f_{H} radiated from the primary radiator 1 longer than the route length from the primary radiator 1 to the reflection surface of the primary reflector 2 of the radio wave RW_{L} of the low frequency f_{L} radiated from the primary radiator 1 is disposed between the primary radiator 1 and the primary reflector 2, so that the reflector antenna device according to Embodiment 1 can have high aperture efficiency in a wide frequency band.

Furthermore, the secondary reflector 3 that equalizes the rate λ_{L}/d_{L} of the wavelength λ_{L} of the radio wave RW_{L} of the low frequency f_{L} radiated from the primary radiator 1, and the route length difference di that is the length between the wavefront of the spherical wave of the radio wave RW_{L} of the low frequency f_{L} incident on the primary reflector 2, and the surface of the dielectric plate 21 of the primary reflector 2, and the rate λ_{H}/d_{H} of the wavelength λ_{H} of the radio wave RW_{H} of the high frequency f_{H} radiated from the primary radiator 1, and the route length difference dx that is the length between the wavefront of the spherical wave of the radio wave RW_{H} of the high frequency f_{H} incident on the primary reflector 2, and the surface of the dielectric plate 21 is disposed between the primary radiator 1 and the primary reflector 2, so that the reflector antenna device according to Embodiment 1 can have high aperture efficiency in a wide frequency band.

Furthermore, the secondary reflector 3 includes the plurality of reflection holes that each have the one end that is the opening and the other end that is the bottom in the reflection surface to adjust the route lengths of the radio waves, so that it is possible to configure the secondary reflector 3 by a simple configuration.

Note that any components in the embodiment can be modified, or any components in the embodiment can be omitted.

### INDUSTRIAL APPLICABILITY

The reflector antenna device according to the present disclosure is suitable for a reflect array antenna that includes a primary radiator and a reflector of a flat plate shape.

### REFERENCE SIGNS LIST

1: primary radiator, 2: primary reflector, 21: dielectric plate, 22: resonance element, 23: metal plate, 3: secondary reflector, 31: reflection hole, f_{L}, f_{M}, f_{H}: frequency, Δ, Δ_{L}, Δ_{M}, Δ_{H}: wavelength, d_{L}, d_{M}, d_{H}: route length difference

1. A reflector antenna device comprising:
a primary radiator to radiate a radio wave of a set frequency band;
a primary reflector including a dielectric plate of a flat plate shape, and a plurality of resonance elements that are aligned on a surface of the dielectric plate that is a reflection surface for reflecting the radio wave, and each adjust a phase of a reflected wave of the incident radio wave; and
a secondary reflector including a reflection surface on which the radio wave radiated from the primary radiator is incident and that reflects the incident radio wave toward the primary reflector, the reflection surface making a route length from the primary radiator to the reflection surface of the primary reflector of a radio wave of a high frequency in the frequency band radiated from the primary radiator longer than a route length from the primary radiator to the reflection surface of the primary reflector of a radio wave of a low frequency in the frequency band radiated from the primary radiator.

2. A reflector antenna device comprising:
a primary radiator to radiate a radio wave of a set frequency band;
a primary reflector including a dielectric plate of a flat plate shape, and a plurality of resonance elements that are aligned on a surface of the dielectric plate that is a reflection surface for reflecting the radio wave, and each adjust a phase of a reflected wave of the incident radio wave; and
a secondary reflector including a reflection surface on which the radio wave radiated from the primary radiator is incident and that reflects the incident radio wave toward the primary reflector, the reflection surface equalizing a rate Δ_{L}/d_{L} of a wavelength λ_{L} of a radio wave of a low frequency in the frequency band radiated from the primary radiator, and a route length difference di that is a length between a wavefront of a spherical wave of the radio wave of the low frequency incident on the primary reflector, and the surface of the dielectric plate, and a rate λ_{H}/d_{H} of a wavelength λ_{H} of a radio wave of a high frequency in the frequency band radiated from the primary radiator, and a route length difference d_{H} that is a length between a wavefront of a spherical wave of the radio wave of the high frequency incident on the primary reflector, and the surface of the dielectric plate.

3. The reflector antenna device according to claim 1, wherein the reflection surface of the secondary reflector includes a plurality of reflection holes each having a truncated conical shape whose one end is an opening and whose other end is a bottom.

4. The reflector antenna device according to claim 1, wherein
the reflection surface of the secondary reflector includes a plurality of reflection holes each having one end that is an opening and an other end that is a bottom, and
each of the reflection holes has a shape whose hole diameter narrows from the opening to the bottom, the hole diameter at a position close to the opening being set to a diameter that cuts off the incident radio wave of the low frequency, the hole diameter at a position close to the bottom being set to a diameter that cuts off the incident radio wave of the high frequency.

5. The reflector antenna device according to claim 1, wherein
the reflection surface of the secondary reflector includes a plurality of reflection holes each having one end that is an opening and an other end that is a bottom, and
an area of an opening surface of the opening of each of the reflection holes is wider than an area of a surface of the bottom.

6. The reflector antenna device according to claim 1, wherein
the reflection surface of the secondary reflector includes a plurality of reflection holes each having one end that is an opening and an other end that is a bottom, and
each of the reflection holes has a shape that becomes smaller from the opening to the bottom stepwise.

7. The reflector antenna device according to claim 3, wherein a shape of a cross section parallel to the opening of each of the reflection holes of the secondary reflector is circular.

8. The reflector antenna device according to claim 4, wherein a shape of a cross section parallel to the opening of each of the reflection holes of the secondary reflector is circular.

9. The reflector antenna device according to claim 5, wherein a shape of a cross section parallel to the opening of each of the reflection holes of the secondary reflector is circular.

10. The reflector antenna device according to claim 6, wherein a shape of a cross section parallel to the opening of each of the reflection holes of the secondary reflector is circular.

11. The reflector antenna device according to claim 3, wherein a shape of a cross section parallel to the opening of each of the reflection holes of the secondary reflector is quadrangular.

12. The reflector antenna device according to claim 4, wherein a shape of a cross section parallel to the opening of each of the reflection holes of the secondary reflector is quadrangular.

13. The reflector antenna device according to claim 5, wherein a shape of a cross section parallel to the opening of each of the reflection holes of the secondary reflector is quadrangular.

14. The reflector antenna device according to claim 6, wherein a shape of a cross section parallel to the opening of each of the reflection holes of the secondary reflector is quadrangular.

15. The reflector antenna device according to claim 1, wherein the radiates radio waves primary radiator of horizontal and vertical polarizations.

16. The reflector antenna device according to claim 1, wherein the primary radiator is a horn antenna.

17. The reflector antenna device according to claim 1, wherein each of the plurality of resonance elements has a circular ring shape.

18. The reflector antenna device according to claim 1, wherein each of the plurality of resonance elements has a circular shape.

19. The reflector antenna device according to claim 1, wherein each of the plurality of resonance elements has a rectangular ring shape.

20. The reflector antenna device according to claim 2, wherein the reflection surface of the secondary reflector includes a plurality of reflection holes each having a truncated conical shape whose one end is an opening and whose other end is a bottom.

21. The reflector antenna device according to claim 2, wherein
the reflection surface of the secondary reflector includes a plurality of reflection holes each having one end that is an opening and an other end that is a bottom, and
each of the reflection holes has a shape whose hole diameter narrows from the opening to the bottom, the hole diameter at a position close to the opening being set to a diameter that cuts off the incident radio wave of the low frequency, the hole diameter at a position close to the bottom being set to a diameter that cuts off the incident radio wave of the high frequency.

22. The reflector antenna device according to claim 2, wherein
the reflection surface of the secondary reflector includes a plurality of reflection holes each having one end that is an opening and an other end that is a bottom, and
an area of an opening surface of the opening of each of the reflection holes is wider than an area of a surface of the bottom.

23. The reflector antenna device according to claim 2, wherein
the reflection surface of the secondary reflector includes a plurality of reflection holes each having one end that is an opening and an other end that is a bottom, and
each of the reflection holes has a shape that becomes smaller from the opening to the bottom stepwise.

24. The reflector antenna device according to claim 20, wherein a shape of a cross section parallel to the opening of each of the reflection holes of the secondary reflector is circular.

25. The reflector antenna device according to claim 21, wherein a shape of a cross section parallel to the opening of each of the reflection holes of the secondary reflector is circular.

26. The reflector antenna device according to claim 22, wherein a shape of a cross section parallel to the opening of each of the reflection holes of the secondary reflector is circular.

27. The reflector antenna device according to claim 23, wherein a shape of a cross section parallel to the opening of each of the reflection holes of the secondary reflector is circular.

28. The reflector antenna device according to claim 20, wherein a shape of a cross section parallel to the opening of each of the reflection holes of the secondary reflector is quadrangular.

29. The reflector antenna device according to claim 21, wherein a shape of a cross section parallel to the opening of each of the reflection holes of the secondary reflector is quadrangular.

30. The reflector antenna device according to claim 22, wherein a shape of a cross section parallel to the opening of each of the reflection holes of the secondary reflector is quadrangular.

31. The reflector antenna device according to claim 23, wherein a shape of a cross section parallel to the opening of each of the reflection holes of the secondary reflector is quadrangular.

32. The reflector antenna device according to claim 2, wherein the primary radiator radiates radio waves of horizontal and vertical polarizations.

33. The reflector antenna device according to claim 2, wherein the primary radiator is a horn antenna.

34. The reflector antenna device according to claim 2, wherein each of the plurality of resonance elements has a circular ring shape.

35. The reflector antenna device according to claim 2, wherein each of the plurality of resonance elements has a circular shape.

36. The reflector antenna device according to claim 2, wherein each of the plurality of resonance elements has a rectangular ring shape.
